(19) United States
(12) Patent Application Publication
(10) Pub. No.: US 2016/0118002 A1
(43) Pub. Date: Apr. 28, 2016

(54) ELECTRO-OPTIC APPARATUS, CONTROL METHOD FOR ELECTRO-OPTIC APPARATUS, AND ELECTRONIC DEVICE

(71) Applicant: SEIKO EPSON CORPORATION, Tokyo (JP)

(72) Inventor: Akihiko ITO, Tatsuno-machi (JP)

(21) Appl. No.: 14/882,876

(22) Filed: Oct. 14, 2015

(30) Foreign Application Priority Data
Oct. 28, 2014 (JP) 2014-219228

(51) Int. Cl. G09G 3/36

(52) U.S. Cl. CPC G09G 3/3614; G09G 3/3685; G09G 3/3674; G09G 2300/0426; G09G 2310/0251; G09G 2310/0297; G09G 2320/0252

(57) ABSTRACT

An electro-optic apparatus includes a control circuit that performs control such that, during a period when one of the scanning lines is selected, the selection circuit selects all of the k data lines during each of a first pre-charge period and a second pre-charge period that are provided in series prior to a period when the data voltages, which are time-division multiplexed in the video signal, are to be supplied to the k data lines and the selected k data lines are supplied with, during the first pre-charge period, a voltage having a predetermined polarity and, during the second pre-charge period, a voltage having the same polarity as identical polarities of the data voltages to be supplied during the period subsequent to the second pre-charge period.

### BACKGROUND

1. Technical Field

The present invention relates to an electro-optic apparatus, a control method for an electro-optic apparatus, and an electronic device.

2. Related Art

A dot matrix display apparatus using an electro-optic element, such as a liquid crystal element, has been well known. For such a display apparatus, a technology for, prior to writing of data voltages into pixels, supplying the pixels with a pre-charge voltage for the purpose of improving a quality of display has been well known. For example, in JP-A-2010-127953, there is disclosed a technology for, in a driving method for inverting the polarities of data voltages at intervals of one frame, performing pre-charging using a voltage whose polarity is negative. Further, in JP-A-2006-259224, there is disclosed a technology for, in a driving method for inverting the polarities of data voltages at intervals of one frame, subsequent to pre-charging using a voltage whose polarity is negative, further performing pre-charging using a voltage whose magnitude is equal to an intermediate electric potential of a video amplitude.

Further, in JP-A-2005-43418, there is disclosed a technology for, in an electro-optic apparatus that is configured such that data lines are sectioned into a plurality of blocks and each of output signals from a driver IC is distributed on a time division basis to a plurality of data lines included in a corresponding one of the blocks and that employs a driving method for inverting the polarities of driving voltages at intervals of one horizontal period, performing pre-charging, for each of the blocks, by using an average voltage of voltages each to be supplied to a corresponding one of the plurality of data lines included in the relevant block.

In the above technology disclosed in JP-A-2010-127953, nevertheless, there has been a problem in that the pre-charging is performed by using a voltage whose polarity is negative and thus particularly when the polarities of data voltages are positive, it takes a long time to perform writing of the data voltages. In the above technology disclosed in JP-A-2006-259294, there has been also a problem in that the relevant technology is not a technology using an electro-optic apparatus that is configured to distribute each of output signals from a driver IC to a plurality of data lines on a time division basis. In the above technology disclosed in JP-A-2005-43418, there has been also a problem in that the relevant technology is not a technology employing a driving method for inverting the polarities of data voltages at intervals of one frame.

### SUMMARY

An advantage of some aspects of the invention is that an electro-optic apparatus that is configured to distribute each of output signals from a driver IC to a plurality of data lines on a time division basis and that employs a driving method for inverting the polarities of data voltages at intervals of one frame; a control method for such an electro-optic apparatus; and an electronic device including such an electro-optic apparatus are provided, which include a technology that makes it possible to make the speed of writing of the data voltages faster than in existing technologies.

An electro-optic apparatus according to a first aspect of the invention includes a plurality of pixels each of which is provided so as to be associated with an intersection of a corresponding scanning line of a plurality of scanning lines and a corresponding data line of a plurality of data lines and each of which, when the corresponding scanning line is selected, performs display at a grayscale level in accordance with an electric potential of the corresponding data line; a data line driving circuit that supplies a signal line with a video signal in which data voltages are time-division multiplexed, the data voltages being voltages each to be supplied to a corresponding one of k data lines (k being an integer satisfying k>1) of the plurality of data lines and having their respective voltage magnitudes and polarities, the voltage magnitudes being determined in accordance with an input video, the polarities being identical polarities that are inverted at intervals of one frame; a selection circuit that selects at least one data line from among the k data lines, each of the at least one data line being a supply destination of the video signal supplied to the signal line; a scanning line driving circuit that selects at least one scanning line from among the plurality of scanning lines; and a control circuit that performs control such that, during a period when one of the scanning lines is selected, the selection circuit selects all of the k data lines during each of a first pre-charge period and a second pre-charge period that are provided in series prior to a period when the data voltages, which are time-division multiplexed in the video signal, are to be supplied to the k data lines and the selected k data lines are supplied with, during the first pre-charge period, a voltage having a predetermined polarity and, during the second pre-charge period, a voltage having the same polarity as identical polarities of the data voltages to be supplied during the period subsequent to the second pre-charge period.

This electro-optic apparatus makes it possible to make the speed of writing of the data voltages faster.

In another electro-optic apparatus according to the first aspect of the invention, the above control circuit may be configured to perform control such that, during the second pre-charge period, the selected k data lines are supplied with a voltage in accordance with an average value of the data voltages which are time-division multiplexed in the video signal and which are to be supplied to the selected k data lines during the period subsequent to the second pre-charge period.

This electro-optic apparatus makes it possible to make the speed of writing of the data voltages faster, as compared with a case where, during the second pre-charge period, the selected k data lines are supplied with a voltage unrelated to the average value of the data voltages.

In another electro-optic apparatus according to the first aspect of the invention, the above control circuit may be configured to perform control such that, during the second pre-charge period, the selected k data lines are supplied with a voltage having a magnitude that differs in accordance with identical polarities of the data voltages which are time-division multiplexed in the video signal and which are to be supplied during the period subsequent to the second pre-charge period.

This electro-optic apparatus makes it possible to make the speed of writing of the data voltages faster, as compared with a case where, during the second pre-charge period, the selected k data lines are supplied with a voltage having a magnitude that is constant independently of the identical polarities of the data voltages.

In another electro-optic apparatus according to the first aspect of the invention, the above control circuit may be configured to, in the case where identical polarities of the data voltages which are time-division multiplexed in the video signal and which are to be supplied during the period subsequent to the second pre-charge period are the same as a polarity of the voltage to be supplied during the first pre-charge period, perform control such that, during the second pre-charge period, the selected k data lines are not supplied with any voltage.

This electro-optic apparatus makes it possible to make the speed of writing of the data voltages faster, as compared with a case where, during the second pre-charge period, the selected k data lines are supplied with a voltage independently of the identical polarities of the data voltages.

In another electro-optic apparatus according to the first aspect of the invention, the above control circuit may be configured to, in the case where identical polarities of the data voltages which are time-division multiplexed in the video signal and which are to be supplied during the period subsequent to the second pre-charge period are the same as a polarity of the voltage to be supplied during the first pre-charge period, perform control such that, during the second pre-charge period, the selected k data lines are supplied with a voltage having a predetermined magnitude.

This electro-optic apparatus makes it possible to make the configuration of the apparatus simpler, as compared with a case where, during the second pre-charge period, the selected k data lines are supplied with a voltage that is determined in accordance with the data voltages.

In another electro-optic apparatus according to the first aspect of the invention, the above data line driving circuit may be configured to perform the voltage supply during the second pre-charge period.

This electro-optic apparatus makes it possible to make the configuration of the apparatus simpler, as compared with a case where a circuit for supplying the data voltages and a circuit for supplying the pre-charge voltage are separately provided.

In another electro-optic apparatus according to the first aspect of the invention, the above control circuit may be configured to perform control so as to cause the selection circuit to select one of the k data lines and another one of the k data lines such that a portion of a period when the one of the k data lines is selected overlaps a period when the another one of the k data lines is selected.

This electro-optic apparatus makes it possible to make the speed of writing of the data voltages faster, as compared with a case where a period when one of the k data lines is selected does not overlaps a period when any other one of the k data lines is selected.

In another electro-optic apparatus according to the first aspect of the invention, the above control circuit may be configured to perform control so as to cause the selection circuit to select one of the k data lines and another one of the k data lines such that half a period when the one of the k data lines is selected overlaps a period when the another one of the k data lines is selected.

This electro-optic apparatus makes it possible to make the configuration of the apparatus simpler, as compared with a case where a portion shorter than half a period when one of the k data lines is selected overlaps a period when another one of the k data lines is selected.

A control method for an electro-optic apparatus, according to a second aspect of the invention, is a method for controlling an electro-optic apparatus including a plurality of pixels each of which is provided so as to be associated with an intersection of a corresponding scanning line of a plurality of scanning lines and a corresponding data line of a plurality of data lines and each of which, when the corresponding scanning line is selected, performs display at a grayscale level in accordance with an electric potential of the corresponding data line. Further, the control method for such an electro-optic apparatus includes supplying a signal line with a video signal in which data voltages are time-division multiplexed, the data voltages being voltages each to be supplied to a corresponding one of k data lines (k being an integer satisfying k>1) of the plurality of data lines and having their respective voltage magnitudes and polarities, the voltage magnitudes being determined in accordance with an input video, the polarities being identical polarities that are inverted at intervals of one frame; selecting at least one data line from among the k data lines, each of the at least one data line being a supply destination of the video signal which is supplied to the signal line; selecting at least one scanning line from among the plurality of scanning lines; during a period when one of the scanning lines is selected, selecting all of the k data lines during each of a first pre-charge period and a second pre-charge period that are provided in series prior to a period when the data voltages, which are time-division multiplexed in the video signal, are to be supplied to the k data lines, and supplying the selected k data lines with, during the first pre-charge period, a voltage having a predetermined polarity and, during the second pre-charge period, a voltage having the same polarity as identical polarities of the data voltages to be supplied during the period subsequent to the second pre-charge period.

This control method makes it possible to make the speed of writing of the data voltages faster.

Moreover, an electronic device according to a third aspect of the invention includes any one of the above electro-optic apparatuses according to the first aspect of the invention.

This electronic device makes it possible to make the speed of writing of the data voltages faster.

### BRIEF DESCRIPTION OF THE DRAWINGS

The invention will be described with reference to the accompanying drawings, wherein like numbers reference like elements.

FIG. 1 is a diagram illustrating an external view of an electro-optic apparatus according to an embodiment of the invention.

FIG. 2 is a diagram illustrating a structure of an electro-optic apparatus according to an embodiment of the invention.

FIGS. 3A and 3B are diagrams illustrating a structure of a liquid crystal panel according to an embodiment of the invention.

FIG. 4 is a diagram illustrating an equivalent circuit for a pixel according to an embodiment of the invention.

FIG. 5 is a timing chart illustrating operation of an electro-optic apparatus according to a related technology.

FIG. 6 is a timing chart illustrating operation according to an operation example 1 of an electro-optic apparatus according to an embodiment of the invention.

FIGS. 7A and 7B are diagrams each illustrating an example of the magnitude of a second pre-charge voltage.

FIG. 8 is a timing chart illustrating operation according to an operation example 2 of an electro-optic apparatus according to an embodiment of the invention.

FIG. 9 is a diagram exemplifying a projector according to an embodiment of the invention.

FIG. 10 is a timing chart illustrating operation according to a modification example of an electro-optic apparatus according to an embodiment of the invention.

### DESCRIPTION OF EXEMPLARY EMBODIMENTS

### 1. Configuration

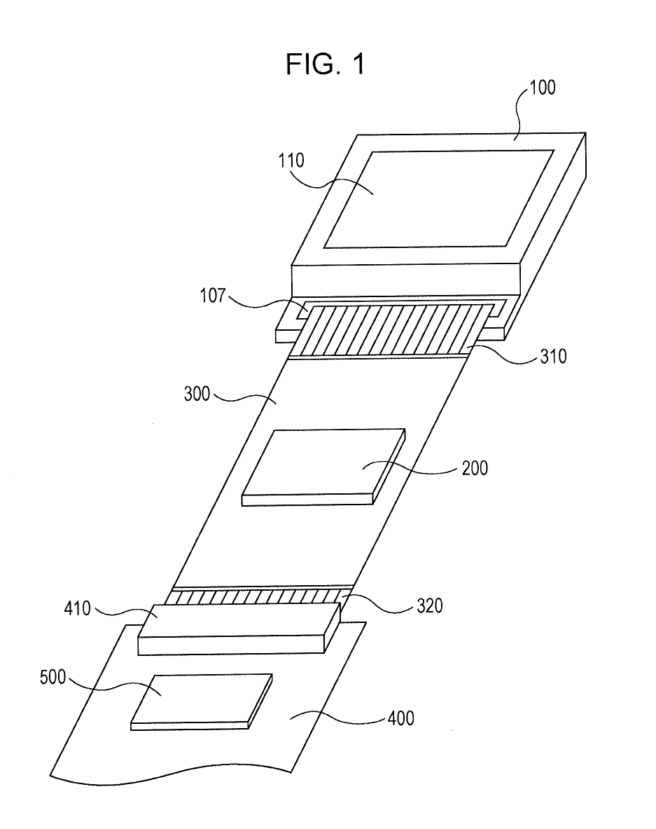

FIG. 1 is a diagram illustrating an external view of an electro-optic apparatus 1 according to an embodiment of the invention. This electro-optic apparatus 1 is, for example, a liquid crystal apparatus used as a light valve of a projector. The electro-optic apparatus 1 includes a liquid crystal panel 100, a data line driving circuit 200, a flexible printed circuit (FPC) substrate 300, a circuit substrate 400, and a control circuit 500. The data line driving circuit 200 is provided on the FPC substrate 300. The control circuit 500 for controlling the electro-optic apparatus 1 is provided on the circuit substrate 400. The circuit substrate 400 and the crystal liquid panel 100 are electrically connected to each other via the FPC substrate 300. The circuit substrate 400 and the FPC substrate 300 are connected to each other via a connector 410 and a connector 320. The FPC substrate 300 and the liquid crystal panel 100 are connected to each other via a connector 310 and a connector 107. The electro-optic apparatus 1 operates in accordance with signals supplied from a host apparatus (omitted from illustration).

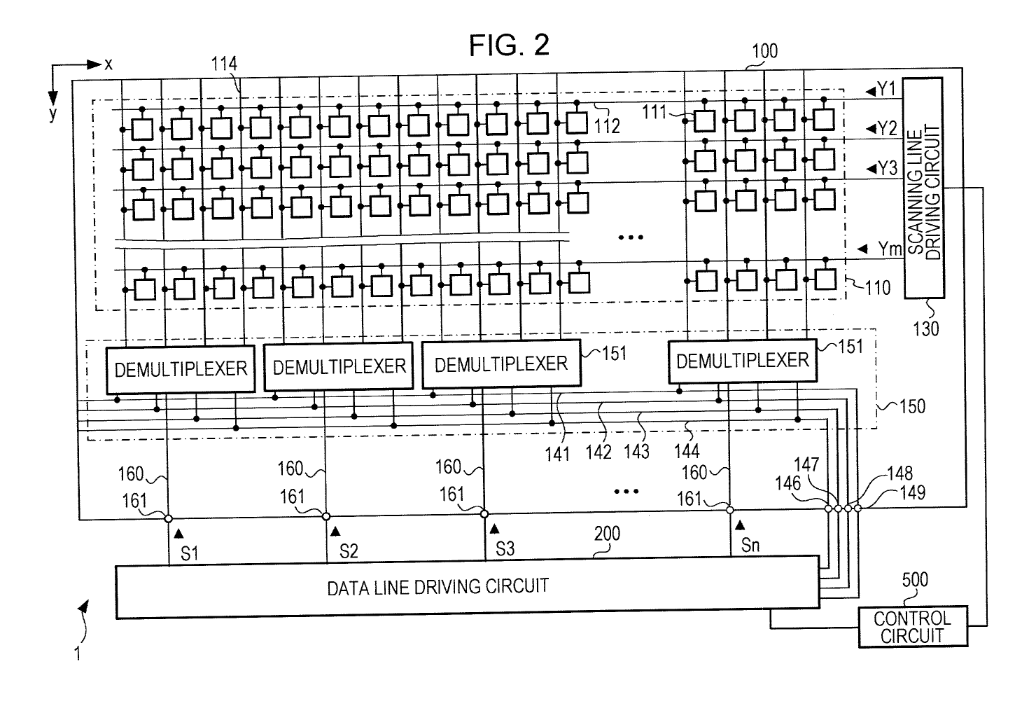

FIG. 2 is a schematic diagram illustrating a configuration of the electrophoretic apparatus 1 and, more particularly, a configuration of the liquid crystal panel 100. The data line driving circuit 200 outputs video signals, on the basis of which images are displayed on the liquid crystal panel 100, in accordance with clock signals, control signals, and video signals, these kinds of signals being input from the control circuit 500. The liquid crystal panel 100 displays images thereon in accordance with clock signals and video signals, these kinds of signals being input from the data line driving circuit 200 and other circuits.

The liquid crystal panel includes an image area 110; a scanning line driving circuit 130; a data line selection circuit 150; n video signal lines 160; n video signal input terminals 161; k selection signal lines (k=4 in the example shown in FIG. 2, that is, a selection signal line 141, a selection signal 142, a selection signal 143, and a selection signal 144); and k selection control signal input terminals (k=4 in the example shown in FIG. 2, that is, a selection control signal input terminal 146, a selection control signal input terminal 147, a selection control signal input terminal 148, and a selection control signal input terminal 149).

The image area 110 is an area in which images are displayed. The image area 110 includes m scanning lines 112; (k×n) data lines 114; and (m×k×n) pixels 111. The scanning lines 112 are signal lines on which scanning signals are transmitted, and are provided so as to extend in a row direction (in an x direction). The data lines 114 are signal lines on which data signals are transmitted, and are provided so as to extend in a column direction (in a y direction). The scanning lines 112 are electrically isolated from the data lines 114. Each of the pixels 111 is provided so as to correspond to an intersection of one of the scanning lines 112 and one of the data lines 114 when the crystal liquid panel 100 is viewed in a z direction (i.e., in a direction perpendicular to the x direction and the y direction). That is, the pixels 111 are arrayed in a matrix shape of m rows and (k×n) columns. Further, in this example, every k pixels 111 that are consecutively arranged in the row direction constitute a pixel group (a block). Pixels 111 belonging to a certain block are electrically connected to an identical video signal line 160 via the data line selection circuit 150. That is, the liquid crystal panel 100 includes n pixel groups resulting from sectioning the pixels 111 into n blocks. The details of the pixels 111 will be described below. When required to identify each of the plurality of scanning lines 112 in the following description, the scanning lines 112 will be represented by a 1st row, a 2nd row, a 3rd row, . . . , and an m-th row scanning line 112. Further, when required to identify each of the plurality of data lines 114, the data lines 114 will be represented by a 1st column, a 2nd column, a 3rd column, . . . , and a (k×n)th column data line 114. Similarly, the video signal lines 160 will be represented by a 1st column, a 2nd column, a 3rd column, . . . , and an n-th column video signal line 160.

The scanning line driving circuit 130 selects a row corresponding to pixels 111 which constitute the plurality of pixels 111 arrayed in the matrix shape, and into each of which a corresponding one of data voltages is to be written. Specifically, the scanning driving circuit 130 outputs a scanning signal that selects one of the scanning lines 112 from among the plurality of scanning signals 112. The scanning line driving circuit 130 supplies a 1st row, a 2nd row, a 3rd row, . . . , and an m-th row scanning line 112 with a scanning signal Y1, Y2, Y3, . . . , and a scanning signal Ym, respectively. In this example, the scanning signals Y1, Y2, Y3, . . . , and Ym are signals each of which sequentially and exclusively becomes a high level.

Further, a selection signal SEL[1], SEL[2], SEL[3], and SEL[4] input from the selection control signal input terminal 146, 147, 148, and 149 are transmitted on the selection signal line 141, 142, 143, and 144, respectively. The selection signals SEL[1], SEL[2], SEL[3], and SEL[4] are signals each of which sequentially and exclusively becomes a high level.

The data line selection circuit 150 selects, for each of the blocks, at least one column 114 into each of which a data voltage is to be written. Specifically, the data line selection circuit 150 selects at least one column 114 from among k data lines 114 belonging to a relevant block, in accordance with high/low levels of the selection signals SEL[1], SEL[2], SEL[3], and SEL[4]. The data line selection circuit 150 includes n demultiplexers 151 each associated with a corresponding one of the n pixel groups. The detail of the demultiplexer 151 will be described below.

The n video signal lines 160 are signal lines on each of which a video signal S input from a corresponding one of the n video signal input terminals 161 is transmitted to the data line selection circuit 150. The video signal S is a signal including data voltages each to be written into a corresponding one of relevant pixels 111. Here, the “video” means a still image or a moving image. One video signal line 160 is electrically connected to k data lines 114 via the data line selection circuit 150. Thus, data voltages to be supplied to the k data lines 114 are time-division multiplexed in the video signal S.

Further, a video signal S1, S2, S3, . . . , and a video signal Sn are output to a 1st column video signal input terminal 161, a 2nd column video signal input terminal 161, a 3rd column video signal input terminal 161, . . . , and an n-th column video signal input terminal 161, respectively, from the data line driving circuit 200. Further, the selection signal SEL[1], SEL[2], SEL[3], and SEL[4] are output to the selection control signal input terminal 146, 147, 148, and 149, respectively, from the data line driving circuit 200.

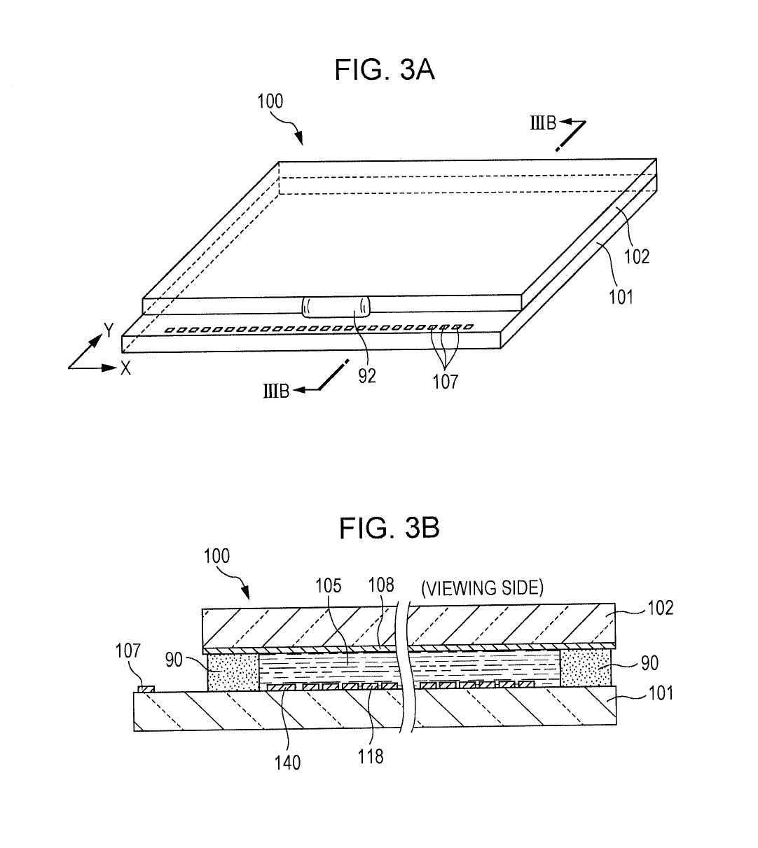

FIG. 3A is a perspective view illustrating a structure of the liquid crystal panel 100. FIG. 3B is a schematic cross-sectional view taking along the line IIIB-IIIB of FIG. 3A. The liquid crystal panel 100 includes an element substrate 101, an opposite substrate 102, and liquid crystal 105. The element substrate 101 and the opposite substrate 102 are mutually bonded such that their respective electrode forming surfaces face each other and a twin sealing material 90 including spacers (omitted from illustration) keeps a distance therebetween to a constant size and thereby forms a space therebetween. The liquid crystal 105 is sealed inside this space. The liquid crystal 105 is liquid crystal of, for example, a vertical alignment (VA) type.

The element substrate 101 and the opposite substrate 102 each have a substrate made of a material having transparency, such as glass or quartz. The y-direction size of the element substrate 101 is longer than that of the opposite substrate 102. The rear side face of the element substrate 101 and that of the opposite substrate 102 align, and thus, the front side face of the element substrate 101 protrudes longer than that of the opposite substrate 102. This protruded portion of the element substrate 101 is provided thereon with a plurality of connectors 107 that are arranged in the x direction. The plurality of connectors 107 are electrically connected to the FPC substrate 300. The FPC substrate 300 includes the data line driving circuit 200 formed thereon. The plurality of connectors 107 are terminals through which various signals, various voltages, video signals, and the like are supplied to the internal of the liquid crystal panel 100 from external circuits, and includes the selection control signal input terminals 146, 147, 148, and 149, and the video signal input terminals 161, these input terminals having been described above.

Further, the element substrate 101 includes pixel electrodes 118 formed on its face facing the opposite substrate 102. The pixel electrodes 118 are electrodes resulting from patterning a conductive layer made of a material having transparency, such as an indium tin oxide (ITO) material. Further, the element substrate 101 includes the scanning line driving circuit 130 formed thereon. The opposite substrate 102 includes a common electrode 108 formed on its face facing the element substrate 101 and, similarly, this common electrode 108 is a conductive layer made of a material having transparency, such as an ITO material.

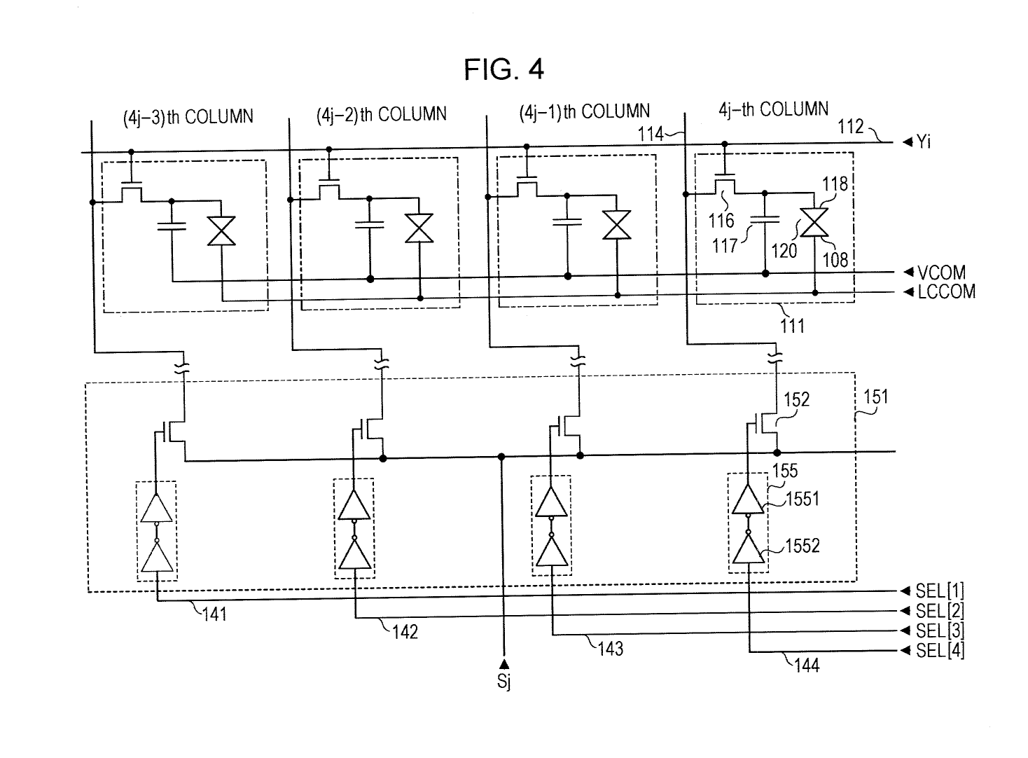

FIG. 4 is a diagram illustrating equivalent circuits for some of the pixels 111. In FIG. 4, there is also illustrated the demultiplexer 151 associated with the relevant pixels 111 each located at a corresponding one of (4j−3)th to 4j-th columns on an i-th row (i being an integer satisfying 1≦i≦m, j being an integer satisfying 1≦j≦n). One block is composed of k pixels 111 on the i-th row (k=4 in this example). One pixel 111 includes a thin film transistor (TFT) 116, the pixel electrode 118, the liquid crystal layer 120, the common electrode 108, and a storage capacitor 117. The TFT 116 is a switching element for controlling writing of data into the pixel electrode 118 (i.e., supplying of a voltage to the pixel electrode 118), and is an n-channel type field-effect transistor in this example. In the TFT 116, its gate electrode is electrically connected to one of the scanning lines 112; its source electrode is electrically connected to one of the data lines 114; and its drain electrode is electrically connected to the pixel electrode 118. Upon supply of a high-level scanning signal to the scanning line 112, the TFT 116 comes into ON state and, as a result, the impedance between the data line 114 and the pixel electrode 118 becomes low. That is, data is written into the pixel electrode 118. Upon supply of a low-level scanning signal to the scanning line 112, the TFT 116 comes into OFF state and, as a result, the impedance between the data line 114 and the pixel electrode 118 becomes high. The common electrode 108 is common to all the pixels 111. The common electrode 108 is supplied with a common voltage LCCOM from, for example, the data line driving circuit 200. The liquid crystal layer 120 is supplied with a voltage equivalent to an electric potential difference between the pixel electrode 118 and the common electrode 108, and this voltage causes the optical characteristic (the reflectance or transmittance) of the liquid crystal layer 120 to vary. The storage capacitor 117 is electrically connected in parallel to the liquid crystal layer 120 and retains electric charges equivalent to an electric potential difference between the pixel electrode 118 and a common voltage VCOM (this common voltage VCOM being equal to the common voltage LCCOM in this example). In the following description, when required to identify each of pixels 111 belonging to a specific block, the relevant pixel 111 will be represented by a sign “pixel 111[s]” (s being an integer satisfying 1≦s≦k). Similarly, the elements included in the pixel 111, such as the TFT 116, will be also represented in the same way.

The demultiplexer 151 is a circuit for supplying a video signal S to at least one data line 114 selected in accordance with high/low levels of the selection signals SEL[1] to SEL[4]. The demultiplexer 151 includes one video signal input terminal, k selection control signal input terminals, k video signal output terminals, and k TFTs 152 (k=4 in this example). Each of the TFTs 152 is a switching element for selecting a corresponding data line 114 electrically connected to its drain electrode in accordance with a high level of a corresponding selection signal SEL input to its gate electrode.

The gate electrode of the TFT 152[1] is electrically connected to the selection signal line 141; the source electrode thereof is electrically connected to the video signal line 160 corresponding to a j-th column; and the drain electrode thereof is electrically connected to the data line 114 corresponding to a (4j−3)th column (i.e., the source electrode of a TFT 116[1] included in a pixel group corresponding to the j-th column). Upon supply of a high level signal of the selection signal SEL[1], the TFT 152[1] becomes into ON state and, as a result, the impedance between the video signal line 160 corresponding to the j-th column and the data line 114 corresponding to the (4j−3)th column becomes low. That is, a video signal Sj is supplied to the data line 114 corresponding to the (4j−3)th column. Upon supply of a low level signal of the selection signal SEL[1], the TFT 152[1] comes into OFF state and, as a result, the impedance between the video signal line 160 corresponding to the j-th column and the data line 114 corresponding to the (4j−3)th column becomes high.

The gate electrode of the TFT 152[2] is electrically connected to the selection signal line 142; the source electrode thereof is electrically connected to the video signal line 160 corresponding to the j-th column; and the drain electrode thereof is electrically connected to the data line 114 corresponding to a (4j−2)th column (i.e., the source electrode of a TFT 116[2] included in the pixel group corresponding to the j-th column). Upon supply of a high level signal of the selection signal SEL[2], the TFT 152[2] comes into ON state and, as a result, the video signal line 160 corresponding to the j-th column and the data line 114 corresponding to the (4j−2)th column come into a conduction state. That is, the video signal Sj is supplied to the data line 114 corresponding to the (4j−2)th column. Upon supply of a low level signal of the selection signal SEL[2], the TFT 152[2] comes into OFF state and, as a result, the impedance between the video signal line 160 corresponding to the j-th column and the data line 114 corresponding to the (4j−2)th column becomes high.

The gate electrode of the TFT 152[3] is electrically connected to the selection signal line 143; the source electrode thereof is electrically connected to the video signal line 160 corresponding to the j-th column; and the drain electrode thereof is electrically connected to the data line 114 corresponding to a (4j−1)th column (i.e., the source electrode of a TFT 116[3] included in the pixel group corresponding to the j-th column). Upon supply of a high level signal of the selection signal SEL[3], the TFT 152[3] comes into ON state and, as a result, the video signal line 160 corresponding to the j-th column and the data line 114 corresponding to the (4j−1)th column come into a conduction state. That is, the video signal Sj is supplied to the data line 114 corresponding to the (4j−1)th column. Upon supply of a low level signal of the selection signal SEL[3], the TFT 152[3] transits into OFF state and, as a result, the impedance between the video signal line 160 corresponding to the j-th column and the data line 114 corresponding to the (4j−1)th column becomes high.

The gate electrode of the TFT 152[4] is electrically connected to the selection signal line 144; the source electrode thereof is electrically connected to the video signal line 160 corresponding to the j-th column; and the drain electrode thereof is electrically connected to the data line 114 corresponding to a 4j-th column (i.e., the source electrode of a TFT 116[4] included in the pixel group corresponding to the j-th column). Upon supply of a high level signal of the selection signal SEL[4], the TFT 152[4] comes into ON state and, as a result, the video signal line 160 corresponding to the j-th column and the data line 114 corresponding to the 4j-th column come into a conduction state. That is, the video signal Sj is supplied to the data line 114 corresponding to the 4j-th column. Upon supply of a low level signal of the selection signal SEL[4], the TFT 152[4] comes into OFF state and, as a result, the impedance between the video signal line 160 corresponding to the j-th column and the data line 114 corresponding to the 4j-th column becomes high.

The demultiplexer 151 is supplied with the video signal S input from one of the video, via one of the video signal lines 160. In the demultiplexer 151, the video signal line 160 is branched to the plurality of TFTs 152[1] to 152[4]. In addition, in this example, the demultiplexer 151 includes waveform shaping circuits 155. The waveform shaping circuits 155 may be omitted.

In summary, each of the plurality of pixels 111 is provided so as to correspond to an intersection of a corresponding scanning line 112 of the plurality of scanning lines 112 and a corresponding data line 114 of the plurality of data lines 114, and performs display at a grayscale level in accordance with an electric potential of the corresponding data line 114 when the corresponding scanning line 112 is selected. The data line driving circuit 200 supplies each of the video signal lines 160 with a video signal in which data voltages are time-division multiplexed, the data voltages being voltages each to be supplied to a corresponding one of k data lines (k being an integer satisfying k>1) of the plurality of data lines 114 and having their respective voltage magnitudes and polarities, the voltage magnitudes being determined in accordance with an input video, the polarities being identical polarities that are inverted at intervals of one frame. The data line selection circuit 150 selects at least one data line 114 from among the k data lines 114, each of the at least one data line 114 being a supply destination of the video signal supplied to the video signal line 160. The scanning line driving circuit 130 selects at least one scanning line 112 from among the plurality of scanning lines 112. The control circuit 500 performs control such that, during a period when one of the scanning lines 112 is selected, the data line selection circuit 150 selects all of the k data lines 114 during each of a first pre-charge period and during a second pre-charge period that are provided in series prior to a period when data voltages which are time-division multiplexed in the video signal are to be supplied to the k data lines, and the selected k data lines are supplied with, during the first pre-charge period, a voltage having a predetermined polarity and, during the second pre-charge period, a voltage having the same polarity as identical polarities of the data voltages to be supplied during the period subsequent to the second pre-charge period.

### 2. Operation

### 2.1 Outline

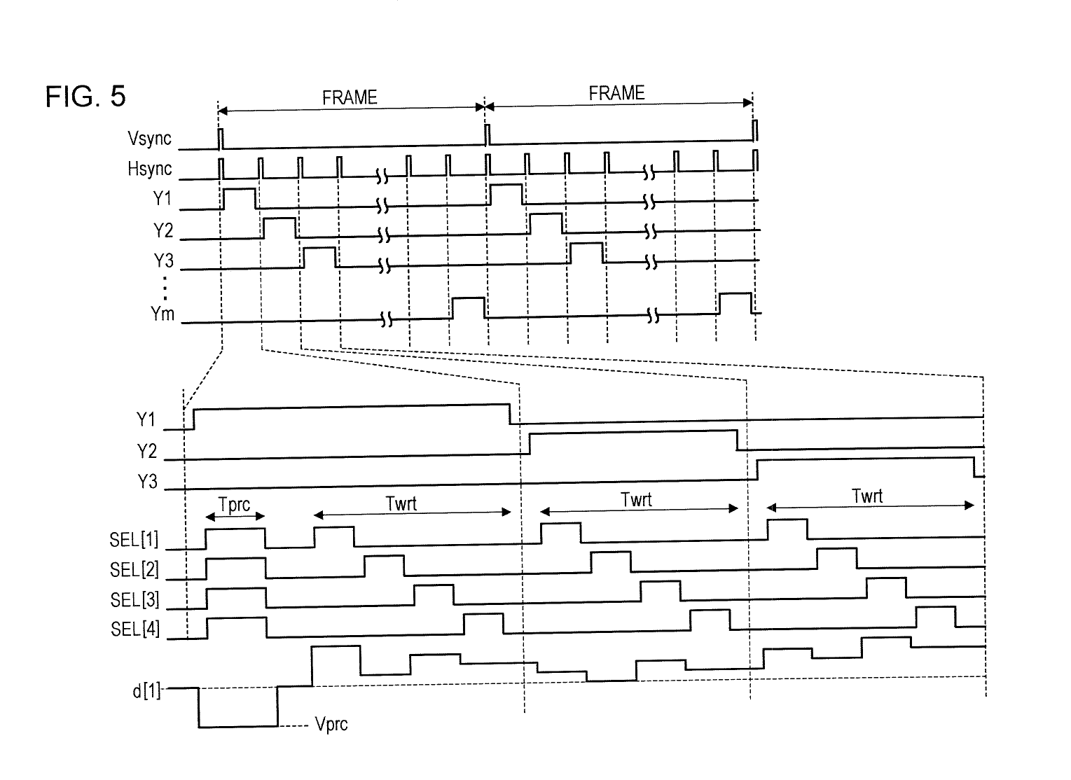

FIG. 5 is a timing chart illustrating operation of an electro-optic apparatus according to a related technology. A vertical synchronization signal Vsync indicates timing of vertical synchronization, that is, a start point of each frame. The identical polarities of data voltages that are time-division multiplexed in each video signal are inverted at intervals of one frame. That is, in this example, a driving method for an electro-optic apparatus is a so-called frame inversion driving method. A horizontal synchronization signal Hsync indicates timing of horizontal synchronization, that is, timing of switching a scanning line 12 to be selected. In addition, in this example, the lengths of horizontal periods are not constant, but vary because of a reason described below. In this example, scanning signals Y1 to Ym sequentially and exclusively select the 1st to m-th scanning lines 12 one by one, respectively.

Each of the horizontal periods includes a period when data voltages are each written into a corresponding one of data lines 114 included in one block (hereinafter, the period being referred to as a “writing period Twrt”). In each block, the writing period Twrt includes a period when a data line 114 to be supplied with a corresponding data voltage is sequentially selected from among k data lines 114 included in the relevant block.

Some horizontal periods include a pre-charge period Tprc. This pre-charge period is a period when pre-charging is performed. This pre-charging is an operation of charging (or discharging) a target data line 114 (and liquid crystal 115 corresponding thereto) in advance in order to compensate a writing lack during a writing period (the writing lack being a phenomenon in which a voltage supply is terminated before the corresponding liquid crystal 115 comes into a desired optical state). During the pre-charge period Tprc, all the data lines 114 are simultaneously selected and are supplied with a pre-charge electric potential Vprc. In view of a quality of display, the pre-charging is preferable to be performed in all the horizontal periods. In this example, however, in order to reduce power consumption simultaneously with making a driving speed fast, the pre-charging is not performed in all the horizontal periods, but is performed in some of the horizontal periods. That is, when attention is focused on a certain frame, all pixels 111 included in the relevant frame are not subjected to the pre-charging, but pixels 111 corresponding to some rows are subjected to the pre-charging. In the example shown in FIG. 5, the pre-charging is performed at intervals of four horizontal periods. That is, the pre-charging is performed during only one horizontal period of every four successive horizontal periods, and is not performed in any other horizontal period of the every four successive horizontal periods.

In addition, in this example, the polarity of the pre-charge electric potential Vprc does not depend on the polarities of data voltages to be supplied during a relevant frame, but is consistently negative. This reason is as follows. For example, parasitic capacitance exists between a data line 114 and a pixel electrode 118 corresponding thereto. Capacitive coupling due to this parasitic capacitance causes an electric-potential variation of the data line 114, and this electric-potential variation thereof influences an electric potential of the pixel electrode 118. In the case of a so-called 1H inversion driving, in which the identical polarities of the data voltages are inverted at intervals of one horizontal period, this influence is hard to be viewed because the influence is canceled at intervals of 1H period, that is, at intervals of one horizontal period. In the case of a frame inversion driving, however, this influence is easy to be viewed because the influence continues for one frame. In order to solve this problem, pre-charging that consistently supplies a negative electric potential independently of the identical polarities of the data voltages is performed.

In the example shown in FIG. 5, however, there has been a problem in that, particularly when the identical polarities of data voltages are positive, there occurs a case where data voltages to be written after pre-charging in which a voltage having a negative polarity is written have positive polarities and, in such a case, a large amount of time is required to perform the writing of the data voltages. In the electro-optic apparatus 1 according to this embodiment, in order to solve this problem, the pre-charging is performed at two stages, that is, during the first pre-charge period and during the second pre-charge period. During the first pre-charge period, a voltage having a predetermined polarity (in this example, a negative polarity) is supplied independently of the identical polarities of the data voltages. During the second pre-charge period, a voltage having the same polarity as the identical polarities of the data voltages is supplied. Hereinafter, more specific operation examples will be described.

### 2.2 Operation Example 1

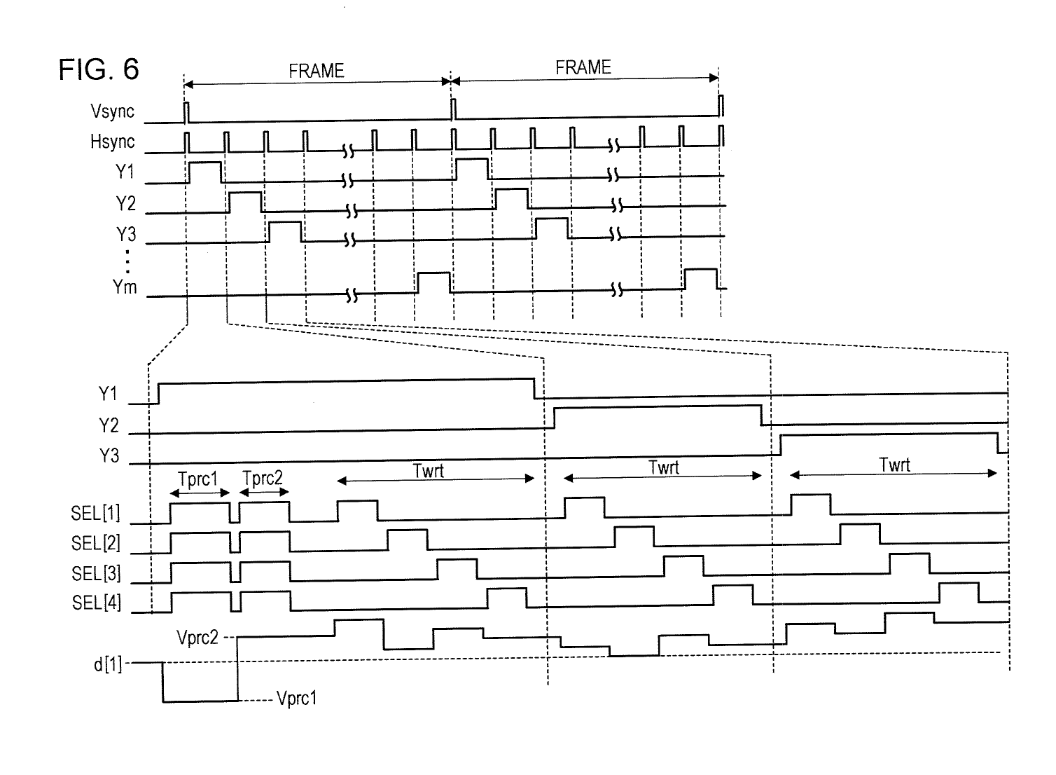

FIG. 6 is a timing chart illustrating operation according to an operation example 1 of the electro-optic apparatus 1. Here, for the following description, only a vertical synchronization signal Vsync, a horizontal synchronization signal Hsync, scanning selection signals SEL[1] to SEL[4], scanning signals Y1 to Y3, and a video signal d[1] are illustrated. This video signal d[1] is a video signal that is supplied to the 1st column video signal line 160.

In this example, pre-charging is performed at intervals of four horizontal periods. All horizontal periods include a writing period Twrt. In this example, the writing period Twrt is a period from timing at which the selection signal SEL[1] becomes a high level until timing at which the selection signal SEL[4] becomes a low level. A horizontal period during which the pre-charging is performed further includes a pre-charge period Tprc1 and a pre-charge period Tprc2. Thus, the time length of the horizontal period during which the pre-charging is performed is longer than that of any other horizontal period during which the pre-charging is not performed.

### 2.2.1 Pre-Charging

During the pre-charge period Tprc1, all the selection signals SEL[1] to SEL[4] become a high level. Thus, all the TFTs 152[1] to 152[4] come into ON state and, as a result, all the data lines 114[1] to 114[4] are supplied with a voltage. At this time, the level of the video signal d[1] output from the data line driving circuit 200 is a first pre-charge voltage Vprc1. That is, the voltage supplied to the data lines 114[1] to 114[4] is the first pre-charge voltage Vprc1. The polarity of the first pre-charge voltage Vprc1 is consistently negative independently of the identical polarities of the data voltages, and the magnitude of the first pre-charge voltage Vprc1 is continuously constant. The magnitude of the first pre-charge voltage Vprc1 is larger than, for example, half a video amplitude.

During the pre-charge period Tprc2, all the selection signals SEL[1] to SEL[4] become a high level. Thus, all the TFTs 152[1] to 152[4] come into ON state and, as a result, the data lines 114[1] to 114[4] are supplied with a voltage. At this time, the level of the video signal d[1] output from the data line driving circuit 200 is a second pre-charge voltage Vprc2. That is, the voltage supplied to the data lines 114[1] to 114[4] is the second pre-charge voltage Vprc2. The polarity of the second pre-charge voltage Vprc2 is the same as the identical polarities of the data voltages. The magnitude of the second pre-charge voltage Vprc2 is, for example, any one of (1), (2), and (3) described below.

(1) A Voltage Determined from an Average Value of Data Voltages in a Relevant Block

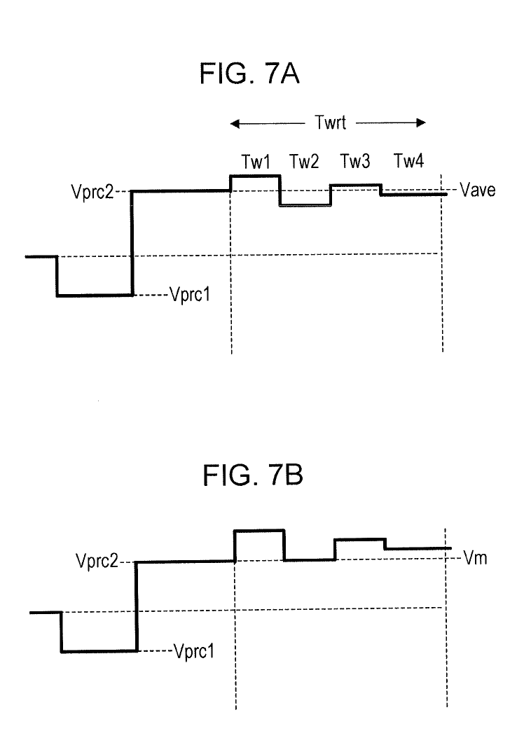

FIG. 7A is a diagram illustrating an example of the magnitude of the second pre-charge voltage Vprc2. In this example, a voltage having a magnitude that is determined on the basis of an average value of data voltages each to be supplied to a corresponding one of the data lines 114 included in the relevant block during a corresponding one of writing periods Tw1 to Tw4 is supplied as the second pre-charge voltage Vprc2. In addition, the writing period Tw1 is a period when a data voltage is written into the data line 114[1] of the k data lines 114 included in the relevant block. Similarly, each of the writing periods Tw2 to Tw4 is a period when a corresponding data voltage is written into a corresponding one of the data lines 114[2] to 114[4] of the k data lines 114 included in the relevant block. Further, the “magnitude that is determined on the basis of an average value” is, for example, the average value itself. Alternatively, the voltage having the “magnitude that is determined on the basis of an average value” may be a voltage having a voltage value closest to the average value among a plurality of preset voltage values (for example, among six stages of voltage values 0, 1, 2, 3, 4, and 5 volts). Moreover, in a different example, a predetermined number of lower ones of bits representing the magnitude of a calculated average value are truncated and a voltage having a magnitude represented by the other upper ones of the bits may be used as the second pre-charge voltage Vprc2.

According to this example, the possibility of making the speed of data writing during a writing period faster, as compared with a case where a voltage having a magnitude unrelated to data voltages to be supplied to the data lines 114[1] to 114[4] included in the relevant block is used. In addition, the second pre-charge voltage Vprc2 is not only determined on the basis of an average value of data voltages to be supplied to data lines included in a single block, but also may be determined on the basis of an average value of data voltages to be supplied to data lines included in a plurality of blocks, or an average value of data voltages to be supplied during one horizontal period. It is possible to realize the simplification of a circuit configuration by employing any one of the above-described configurations.

### (2) A Constant Voltage Independently of an Average Value of Data Voltages in a Relevant Block

FIG. 7B is a diagram illustrating another example of the magnitude of the second pre-charge voltage Vprc2. In this example, the magnitude of the second pre-charge voltage Vprc2 is determined in advance and is, for example, equivalent to a middle voltage Vm of a video amplitude. Specifically, in the case where the video amplitude is 5 volt, the magnitude of the second pre-charge voltage Vprc2 is 2.5 volt. That is, the second pre-charge Vprc2 is equal to +2.5 volt in a positive-polarity frame; while the second pre-charge Vprc2 is equal to −2.5 volt in a negative-polarity frame.

According to this example, it is possible to make the configuration of the control circuit 500 and the configuration of the data line driving circuit 200 simpler, as compared with the case where an average value of data voltages to be supplied to data lines included in a relevant block is used.

(3) A voltage falling within a voltage range (normally, a voltage range of around 0 volt to 1.5 volt or around 0 volt to −1.5 volt) up to around a threshold voltage at which the luminance level of the liquid crystal panel begins to gradually increase from a black level.

A voltage falling within a voltage range (normally, a voltage range of around 0 volt to 1.5 volt or around 0 volt to −1.5 volt) up to around a threshold voltage at which the luminance level of the liquid crystal panel begins to gradually increase from a black level is used as the second pre-charge voltage Vprc2. According to this example, it is possible to prevent lowering of contrast. This voltage may be also taken into consideration in the case where the magnitude of the second pre-charge voltage Vprc2 is determined on the basis of an average value of data voltages, or is a constant voltage.

### 2.2.2 Writing

In this example, the selection signals SEL[1] to SEL[4] are signals that are sequentially and exclusively become a high level. In order to suppress crosstalk between adjacent data lines 114, there exists a time when both the selection signals SEL[1] and SEL[2] become a low level during a period from switching of the selection signal[1] from a high level to a low level until switching of the selection signal[2] from the Low level to the high level. In this way, during each of the writing periods Tw1 to Tw4, a corresponding one of data voltages is sequentially written into a corresponding one of the data lines 114[1] to 114[4].

### 2.3 Operation Example 2

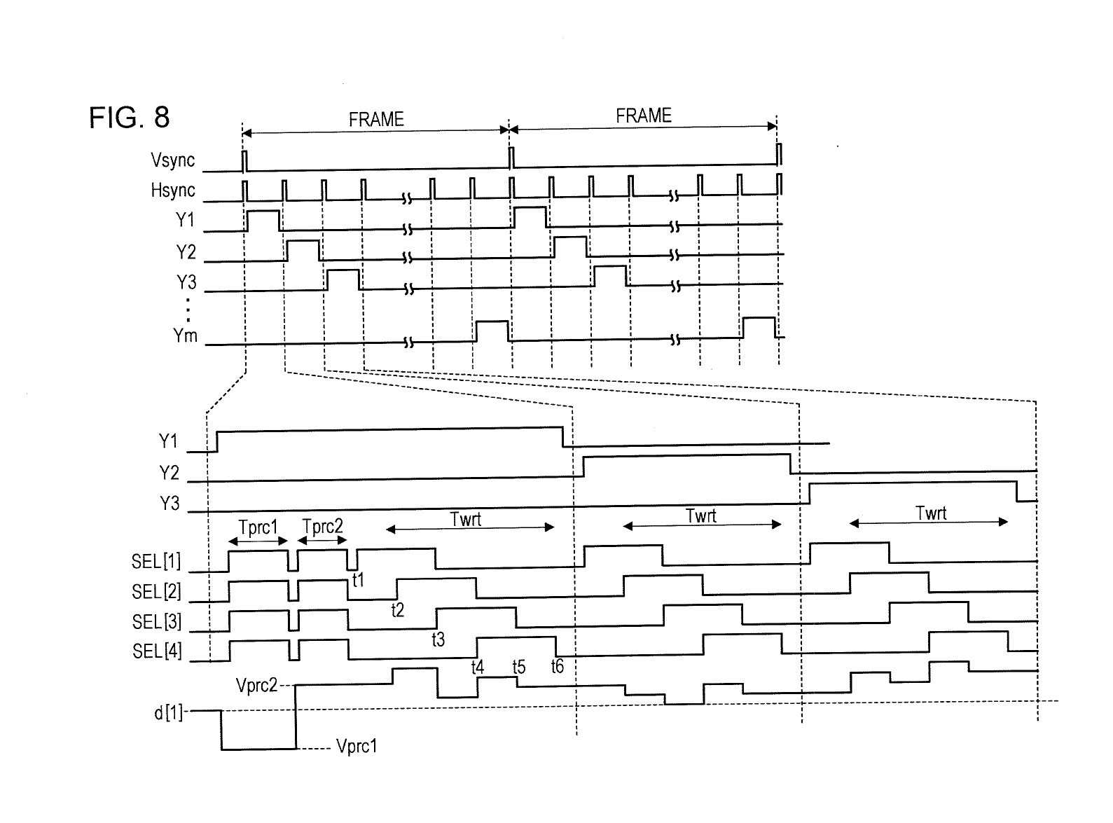

FIG. 8 is a timing chart illustrating operation according to an operation example 2 of the electro-optic apparatus 1. In this operation example 2, selection signals SEL[1] to SEL[4] are not signals that sequentially and exclusively become a high level, but signals every two adjacent ones of which simultaneously become a high level during a partial period. For example, in the example shown in FIG. 8, the selection signal SEL[1] is switched to a high level at a time point t1 and is switched to a low level at a time point t3, and the selection signal SEL[2] is switched to a high level at a time point t2 and is switched to a low level at a time point t4 (herein, t1<t2<t3<t4). Thus, during a period from the time point t2 until the time point t3, both the selection signals SEL[1] and SEL[2] are in a high level state. That is, during the period from the time point t2 until the time point t3, both the data line 114[1] and the data line 114[2] are selected.

During a period from the time point t2 until the time point t3, the signal level of a video signal d[1] corresponds to a data voltage Vd[1] to be supplied to the data line 114[1]. During the period from the time point t2 until the time point t3, the selection signal SEL[2] becomes a high level in addition to the selection signal SEL[1], and thus, the data voltage Vd[1] is also written into the data line 114[2]. During an immediately subsequent period from the time point t3 until the time point t4, a data voltage Vd[2] to be supplied to the data line 114[2], that is, a correct data voltage, is written into the data line 114[2].

During the period from the time point t3 until the time point t4, the selection signal SEL[3] also becomes a high level in addition to the selection signal SEL[2], and thus, the data voltage Vd[2] is also written into the data line 114[3]. During an immediately subsequent period from the time point t4 until the time point t5, however, a data voltage Vd[3] to be supplied to the data line 114[3], that is, a correct data voltage, is written into the data line 114[3].

During the period from the time point t4 until the time point t5, the selection signal SEL[4] also becomes a high level in addition to the selection signal SEL[3], and thus, the data voltage Vd[3] is also written into the data line 114[4]. During an immediately subsequent period from the time point t5 until the time point t6, however, a data voltage Vd[4] to be supplied to the data line 114[4], that is, a correct data voltage, is written into the data line 114[4]. During the period from the time point t5 until the time point t6, only the selection signal SEL[4] becomes a high level.

According to this operation example, as compared with the operation example 1, it is possible to make the writing period Twrt shorter, that is, to make the speed of driving the liquid crystal panel 100 faster. According to this embodiment, it is possible to drive, for example, a liquid crystal panel having a resolution of a so-called 4K2K or more, and thus, it is possible to realize a high-resolution (high-definition) and high-speed liquid crystal display apparatus.

In addition, in the example shown in FIG. 8, during a period when one data line 114 is selected, a period when a different data line 114 is simultaneously selected is equal to a period when the different data line 114 is not simultaneously selected. That is, half a period when one of the k data lines 114 is selected overlaps a period when a different data line 114 is selected. For example, the time length of the period from the time point t1 until the time point t2 is equal to the time length of the period from the time point t2 until the time point t3.

### 3. Application Example

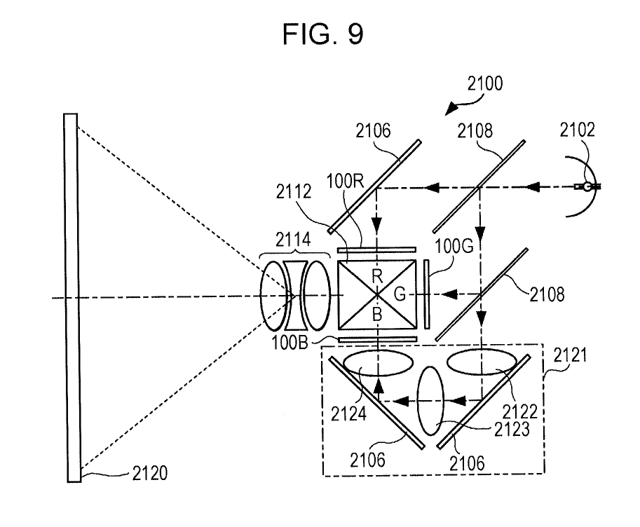

FIG. 9 is a diagram exemplifying a projector 2100 according to an embodiment of the invention. This projector 2100 is an example of electronic devices using the electro-electric apparatus 1. In the projector 2100, the electro-optic apparatus 1 is used as a light valve. As shown in FIG. 9, in the inside of the projector 2100, a lamp unit 2102 including a white light source, such as a halogen lamp, is provided. Projection light rays emitted from the lamp unit 2102 are separated into three kinds of light rays, each kind being associated with a corresponding one of three primary colors, that is, red (R), green (G), and blue (B) colors, by internally-provided three mirrors 2106 and internally-provided two dichroic mirrors 2108. Each of the separated three kinds of light rays is guided to a corresponding one of light valves 100R, 100G, and 100B each associated with a corresponding one of the primary colors. In addition, the light rays of the B color have a longer light propagation path, as compared with that of the light rays of the R color and that of the light rays of the G color, and thus, in order to prevent the loss of the light rays of the B color due to the long light propagation path, the light rays of the B color are guided to the light valve 100B via a relay lens system 2121 including an entrance lens 2122, a relay lens 2123, and an exit lens 2124.

In the projector 2100, three sets of liquid crystal display apparatuses each including the electro-optic apparatus 1 and being associated with a corresponding one of the R, G, and B colors are provided. The configuration of each of the light valves 100R, 1000, and 100B is the same as that of the above-described liquid crystal panel 100. The light valves 100R, 100G, and 100B are each driven by being supplied with a video signal that designates a grayscale level of a corresponding one of primary color elements, that is, R, G, and B color elements, from a corresponding one of external upper circuits. Three kinds of light rays, each kind of which has been subjected to modulation by a corresponding one of the light valves 100R, 100G, and 100B, enter a dichroic prism 2112 from a corresponding one of three direction sides. Further, in the dichroic prism 2112, the light rays of the R color and the light rays of the B color are refracted at 90 degrees, and the light rays of the G color proceed straight. Thus, images of individual primary colors are combined, and then a color image is projected on a screen 2120 by a set of projection lenses 2114.

In addition, each of three kinds of light rays, which is associated with a corresponding one of the R, G, and B colors, is input to a corresponding one of the light valves 100R, 1000, and 100B by the dichroic mirror 2108, and thus, it is unnecessary to provide any color filter. Further, images having been transmitted through the light valves 100R and 100B are projected after having been reflected by the dichroic prism 2112; while an image having been transmitted through the light valve 100G is projected as it is. Thus, each of the light valves 100R and 100B is configured to display a mirror-reversed image by making a horizontal scanning direction therein reverse to a horizontal scanning direction in the light valve 100G.

### 4. Modification Examples

The invention is not limited to the above embodiment and can be practiced as various modification examples of the above embodiment. Hereinafter, some of the various modification examples will be described. Any two or more ones of modification examples described below may be combined and used together.

The method for determining the magnitude of the second pre-charge voltage Vprc2 may be changed depending on to which of two kinds of frames a target second pre-charge period belongs, the two kinds of frames being a frame during which data voltages having positive polarities are written, and a frame during which data voltages having negative polarities are written. For example, in the frame during which data voltages having positive polarities are written, the magnitude of the second pre-charge voltage Vprc2 may be an average value of data voltages to be supplied to data lines included in a relevant block, and in the frame during which data voltages having negative polarities are written, the magnitude of the second pre-charge voltage Vprc2 may be a preset value. Alternatively, in the frame during which data voltages having positive polarities are written, second pre-charging may be performed, and in the frame during which data voltages having negative polarities are written, the second pre-charging may not be performed. In this case, when the time length of a period from the end of the first pre-charge period until the start of the writing period Twrt is made shorter than that of the frame during which data voltages having positive polarities are written, it is possible to make the speed of driving the liquid crystal display apparatus 100 further faster.

In the case where the pre-charging is performed during only some horizontal periods, that is, in the case where the pre-charging is performed on only pixels 111 corresponding to some rows, a combination of rows on each of which the pre-charging is performed may be changed at intervals of one frame (that is, a combination of rows on each of which the pre-charging is performed may be rotated within preset combinations at intervals of one frame). For example, when four successive frames are made one unit, the pre-charging may be performed on the (4i−3)th row in a first frame; the (4i−2)th row in a second frame; the (4i−1)th row in a third frame; and the 4i-th row in a fourth frame. Moreover, order (rotation order) of pre-charging performed on each of rows targeted for the pre-charging may be changed at intervals of four frames. For example, in initial four successive frames, the pre-charging may be performed in order of the (4i−3)th row, the (4i−2)th row, the (4i−1)th row, and the 4i-th row; and in a subsequent four successive frames, the pre-charging may be performed in order of the (4i−2)th row, the (4i−1)th row, the 4i-th row, and the (4i−3)th row.

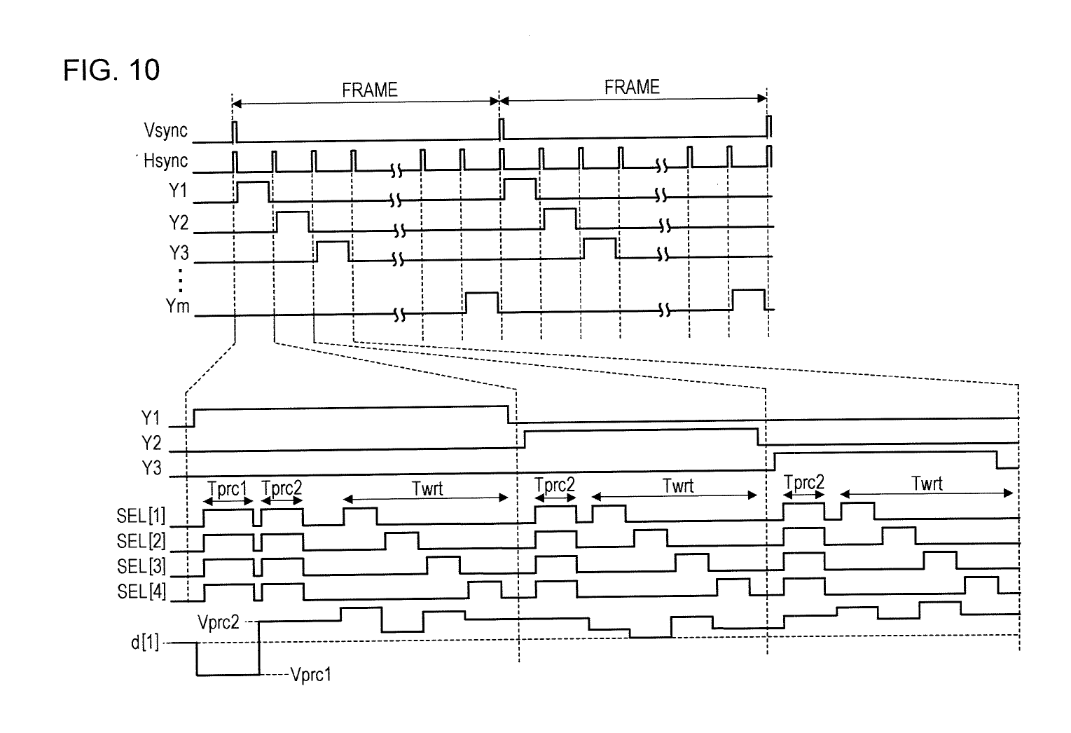

FIG. 10 is a timing chart illustrating operation according to a modification example of the electro-optic apparatus 1. The supply of the second pre-charge voltage may be performed during every horizontal period during which the supply of the first pre-charge voltage is not performed. This method makes it possible to perform writing of video signals after a voltage to be written into each of writing target data lines has been brought into a preset constant condition, and thus, the video signals can be written with higher accuracy.

In the above embodiment, the supply of the first pre-charge voltage is performed once at intervals of four lines (rows), but the frequency of supplying the first pre-charge voltage is not limited to this operation, but may be once, for example, every two lines, every three lines every four lines, or every five lines . . . .

In a certain frame, the pre-charging may be performed in all horizontal periods. That is, the pre-charging may be performed on all pixels included in the certain frame.

The hardware configuration of the electro-optic apparatus 1 is not limited to that having been described in the above embodiment. For example, in the above embodiment, the configuration in which a single driving circuit (the data line selection circuit 150) outputs both of two kinds of voltages, that is, the pre-charge voltages and the data voltages, has been described. But, a circuit that outputs the pre-charge voltages and a circuit that outputs the data voltages may be mutually separate circuits.

In the above operation example 2, during a period when one data line 114 is selected, the time length of a period when a different data line 114 is simultaneously selected may not be equal to the time length of a period when the different data line 114 is not simultaneously selected. For example, the time length of the period when a different data line 114 is simultaneously selected may be shorter than that of the period when the different data line 114 is not simultaneously selected.

Further, n data lines 13 may not be sectioned into groups each consisting of k data lines. That is, when attention is focused on some data lines of the n data lines 13, the some data lines may be subjected to the processing having been described in the above embodiment.

Electronic devices using the electro-optic apparatus 1 include, in addition to the projector having been described as an example of the above embodiment, a television set, a viewfinder type or monitor direct view type video tape recorder, a car navigation system, a pager, an electronic organizer, an electronic calculator, a word processor, a workstation, a video phone, a POS terminal, a digital still camera, a mobile phone, devices each including a touch panel, and the like.

The liquid crystal 115 is not limited to the VA type liquid crystal. Liquid crystal other than the VA type liquid crystal, such as TN type liquid crystal, may be employed as the liquid crystal 115. Further, the liquid crystal 105 may be normally white mode liquid crystal. Moreover, an electric-optic element other than the liquid crystal may be employed. As this electric-optic element, in addition to the liquid crystal, a micro capsulate type electrophoretic display (EPD), an electro-chromic display (ECD), or the like may be employed.

The conduction types of the semiconductors (the TFTs 116 and the like), the signals for use in driving the semiconductors (the selection signals SEL and the like), and the polarities of the voltages (the pre-charge voltages, and the like) are not limited to those having been described in the above embodiment. The signal levels and the voltage levels having been described in the above embodiment are just examples.

The entire disclosure of Japanese Patent Application No. 2014-219228, filed Oct. 28, 2014 is expressly incorporated by reference herein.

What is claimed is:

1. An electro-optic apparatus comprising:
a plurality of pixels each of which is provided so as to be associated with an intersection of a corresponding scanning line of a plurality of scanning lines and a corresponding data line of a plurality of data lines and each of which, when the corresponding scanning line is selected, performs display at a grayscale level in accordance with an electric potential of the corresponding data line;
a data line driving circuit that supplies a signal line with a video signal in which data voltages are time-division multiplexed, the data voltages being voltages each to be supplied to a corresponding one of k data lines (k being an integer satisfying k>1) of the plurality of data lines and having their respective voltage magnitudes and polarities, the voltage magnitudes being determined in accordance with an input video, the polarities being identical polarities that are inverted at intervals of one frame;
a selection circuit that selects at least one data line from among the k data lines, each of the at least one data line being a supply destination of the video signal supplied to the signal line;
a scanning line driving circuit that selects at least one scanning line from among the plurality of scanning lines; and
a control circuit that performs control such that, during a period when one of the scanning lines is selected, the selection circuit selects all of the k data lines during each of a first pre-charge period and a second pre-charge period that are provided in series prior to a period when the data voltages, which are time-division multiplexed in the video signal, are to be supplied to the k data lines and the selected k data lines are supplied with, during the first pre-charge period, a voltage having a predetermined polarity and, during the second pre-charge period, a voltage having the same polarity as identical polarities of the data voltages to be supplied during the period subsequent to the second pre-charge period.

2. The electro-optic apparatus according to claim 1, wherein the control circuit performs control such that, during the second pre-charge period, the selected k data lines are supplied with a voltage in accordance with an average value of the data voltages which are time-division multiplexed in the video signal and which are to be supplied to the selected k data lines during the period subsequent to the second pre-charge period.

3. The electro-optic apparatus according to claim 1, wherein the control circuit performs control such that, during the second pre-charge period, the selected k data lines are supplied with a voltage having a magnitude that differs in accordance with identical polarities of the data voltages which are time-division multiplexed in the video signal and which are to be supplied during the period subsequent to the second pre-charge period.

4. The electro-optic apparatus according to claim 3, wherein, in the case where identical polarities of the data voltages which are time-division multiplexed in the video signal and which are to be supplied during the period subsequent to the second pre-charge period are the same as a polarity of the voltage to be supplied during the first pre-charge period, the control circuit performs control such that, during the second pre-charge period, the selected k data lines are not supplied with any voltage.

5. The electro-optic apparatus according to claim 3, wherein, in the case where identical polarities of the data voltages which are time-division multiplexed in the video signal and which are to be supplied during the period subsequent to the second pre-charge period are the same as a polarity of the voltage to be supplied during the first pre-charge period, the control circuit performs control such that, during the second pre-charge period, the selected k data lines are supplied with a voltage having a predetermined magnitude.

6. The electro-optic apparatus according to claim 1, wherein the data line driving circuit performs the voltage supply during the second pre-charge period.

7. The electro-optic apparatus according to claim 1, wherein the control circuit performs control so as to cause the selection circuit to select one of the k data lines and another one of the k data lines such that a portion of a period when the one of the k data lines is selected overlaps a period when the another one of the k data lines is selected.

8. The electro-optic apparatus according to claim 7, wherein the control circuit performs control so as to cause the selection circuit to select one of the k data lines and another one of the k data lines such that half a period when the one of the k data lines is selected overlaps a period when the another one of the k data lines is selected.

9. A control method for an electro-optic apparatus including a plurality of pixels each of which is provided so as to be associated with an intersection of a corresponding scanning line of a plurality of scanning lines and a corresponding data line of a plurality of data lines and each of which, when the corresponding scanning line is selected, performs display at a grayscale level in accordance with an electric potential of the corresponding data line, the control method comprising:
supplying a signal line with a video signal in which data voltages are time-division multiplexed, the data voltages being voltages each to be supplied to a corresponding one of k data lines (k being an integer satisfying k>1) of the plurality of data lines and having their respective voltage magnitudes and polarities, the voltage magnitudes being determined in accordance with an input video, the polarities being identical polarities that are inverted at intervals of one frame;
selecting at least one data line from among the k data lines, each of the at least one data line being a supply destination of the video signal which is supplied to the signal line;
selecting at least one scanning line from among the plurality of scanning lines; and
during a period when one of the scanning lines is selected, selecting all of the k data lines during each of a first pre-charge period and a second pre-charge period that are provided in series prior to a period when the data voltages, which are time-division multiplexed in the video signal, are to be supplied to the k data lines, and supplying the selected k data lines with, during the first pre-charge period, a voltage having a predetermined polarity and, during the second pre-charge period, a voltage having the same polarity as identical polarities of the data voltages to be supplied during the period subsequent to the second pre-charge period.

10. An electronic device comprising the electro-optic apparatus according to claim 1.

11. An electronic device comprising the electro-optic apparatus according to claim 2.

12. An electronic device comprising the electro-optic apparatus according to claim 3.

13. An electronic device comprising the electro-optic apparatus according to claim 4.

14. An electronic device comprising the electro-optic apparatus according to claim 5.

15. An electronic device comprising the electro-optic apparatus according to claim 6.

16. An electronic device comprising the electro-optic apparatus according to claim 7.

17. An electronic device comprising the electro-optic apparatus according to claim 8.
